(19) United States
(12) Patent Application Publication
(10) Pub. No.: US 2017/0116526 A1
(43) Pub. Date: Apr. 27, 2017

(54) AUTOMATIC TRIGGERING OF LINEAR PROGRAMMING SOLVERS USING STREAM REASONING

(71) Applicant: CISCO TECHNOLOGY, INC., San Jose, CA (US)

(72) Inventor: Samer Salam, Vancouver (CA)

(73) Assignee: CISCO TECHNOLOGY, INC., San Jose, CA (US)

(21) Appl. No.: 14/924,460

(22) Filed: Oct. 27, 2015

(51) Int. Cl. G06N 5/00

(52) U.S. Cl. CPC G06N 5/006

(57) ABSTRACT

In one embodiment, a method includes identifying at a network device, metrics associated with constraints of an optimization problem, receiving values for the metrics from a stream reasoner, obtaining an initial solution of the optimization problem from a linear programming solver based on the values of the metrics, and instructing the linear programming solver to calculate a new solution to the optimization problem when the stream reasoner indicates that the constraints of the optimization problem are violated. An apparatus and logic are also disclosed herein.

### TECHNICAL FIELD

The present disclosure relates generally to communication networks, and more particularly, to network optimization using linear programming.

### BACKGROUND

Many networking problems can be categorized as mathematical optimization problems involving an objective such as the maximizing or minimizing of a set of variables, while subject to a series of constraints. These optimization problems may be modeled using linear programming (LP) formulations and solved using LP solvers, however, there are a number of difficulties in using conventional LP solvers. For example, objectives or constraints may not be supported by a system built on top of the LP solvers and solving the LP problem may be time consuming for large data sets or stringent constraints.

### BRIEF DESCRIPTION OF THE DRAWINGS

FIG. 1 illustrates an example of a network in which embodiments described herein may be implemented.

FIG. 2 depicts an example of a network device useful in implementing embodiments described herein.

FIG. 3 illustrates details of an optimization system in the network of FIG. 1, in accordance with one embodiment.

FIG. 4 illustrates an overview of a process for automatic triggering of LP solvers, in accordance with one embodiment.

FIG. 5 illustrates an example utilizing the embodiments described herein to optimize foglet placement.

Corresponding reference characters indicate corresponding parts throughout the several views of the drawings.

### DESCRIPTION OF EXAMPLE EMBODIMENTS

### Overview

In one embodiment, a method generally comprises identifying at a network device, metrics associated with constraints of an optimization problem, receiving values for the metrics from a stream reasoner, obtaining an initial solution of the optimization problem from a linear programming solver based on the values of the metrics, and instructing the linear programming solver to calculate a new solution to the optimization problem when the stream reasoner indicates that the constraints of the optimization problem are violated.

In another embodiment, an apparatus generally comprises a processor configured to identify metrics associated with constraints of an optimization problem, process values of the metrics received from a stream reasoner, obtain an initial solution of the optimization problem from a linear programming solver based on the values of the metrics, and instruct the linear programming solver to calculate a new solution to the optimization problem when the stream reasoner indicates that the constraints of the optimization problem are violated. The apparatus further comprises memory for storing the metrics and the constraints of the optimization problem.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

Optimization problems may be modeled using Linear Programming (LP) formulations and solved using domain-independent LP solvers. Examples include assignment of flows to links or paths, placement of ACLs (Access Control Lists) on network elements, placement of virtual machines (VMs)/foglets in fog nodes, placement of virtual network functions, assignment of wireless clients to access points, and many others.

Conventional systems built on top of these LP solvers typically hard-code the objective and constraints that the user can specify. From the user's perspective, if the objective or constraints that they want to use are not supported by the system, the user would need to write new code. Furthermore, solving the LP problem may require large processing resources and be time consuming for large data sets or stringent constraints. As such, it is important to be able to determine automatically whether the operating conditions of the compute/network infrastructure are still within bounds specified by the placement or assignment constraints, or whether a new placement or assignment calculation needs to be triggered.

The embodiments described herein provide for automatic triggering of an LP solver when constraints of the LP formulation are violated through the use of semantic stream reasoning. This allows for the automatic determination of when the LP solver needs to be triggered to find a new optimal solution, which is important given the cost associated with solving highly constrained LP formulations. Certain embodiments may also provide the flexibility to support any objective or constraints without the need for writing new code by modeling the optimization problem in network ontology.

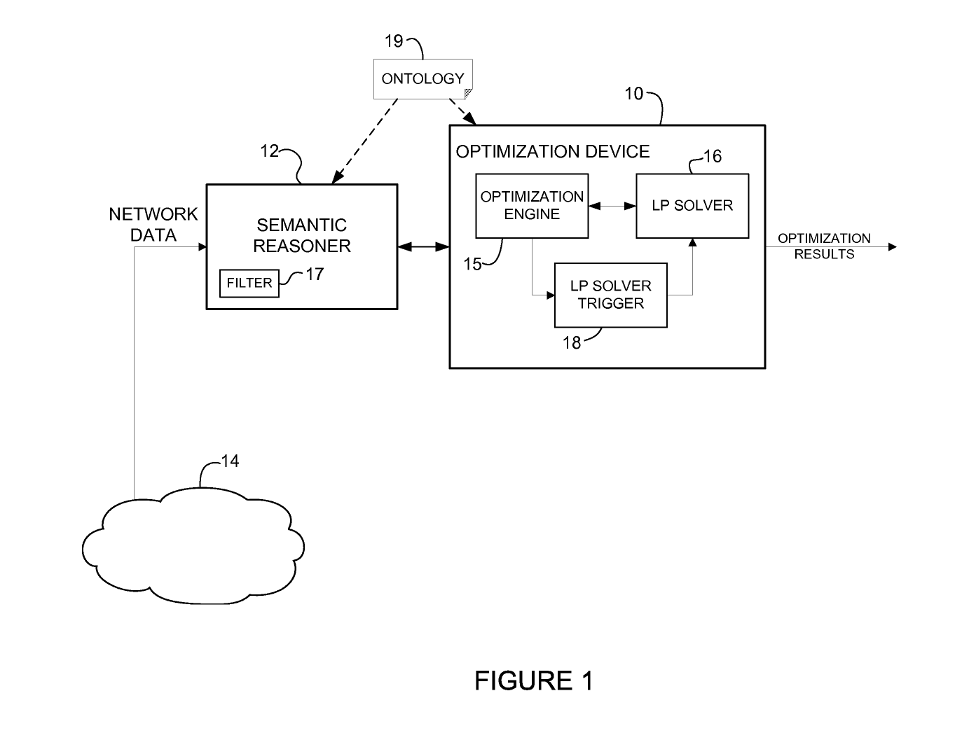

Referring now to the drawings, and first to FIG. 1, a network in which embodiments described herein may be implemented is shown. For simplification, only a small number of nodes are shown. The embodiments operate in the context of a data communication network including multiple network devices. The network may include any number of network devices in communication via any number of nodes (e.g., routers, switches, gateways, controllers, access devices, aggregation devices, core nodes, intermediate nodes, or other network devices), which facilitate passage of data within the network. The nodes may communicate over one or more networks (e.g., local area network (LAN), metropolitan area network (MAN), wide area network (WAN), virtual private network (VPN), virtual local area network (VLAN), wireless network, enterprise network, Internet, intranet, radio access network, public switched network, or any other network).

The network shown in the example of FIG. 1 includes network device (optimization device) 10 in communication with a semantic reasoner 12. The semantic reasoner receives network data from network 14. The data may comprise, for example, data streams and may be provided to the semantic reasoner 12 in any suitable format. In one embodiment, the optimization device 10 comprises an optimization engine 15, LP solver 16, and LP solver trigger mechanism 18.

The optimization engine 10 and semantic reasoner 12 may operate at a controller, server, appliance, or any other network element or general purpose computing device located in the network or in a cloud or fog. The optimization device 10 and stream reasoner 12 may operate at separate network devices or be co-located at the same network device. Also, one or more the components of the optimization device 10 may be located on another network device or distributed in the network.

The optimization device 10 and semantic reasoner 12 may also utilize ontology information from a network ontology file 19, which may be maintained, for example, in an ontology server or other network device or database. The ontology 19 formally represents knowledge as a hierarchy of concepts within a domain (e.g., network) using a shared vocabulary to denote types, properties, and interrelationships of concepts. In particular, the ontology 19 may comprise an explicit representation of a shared conceptualization of the network, providing a formal structural framework for organizing knowledge related to the network as a hierarchy of inter-related concepts. The shared conceptualization may include conceptual frameworks for modeling domain knowledge (e.g., knowledge related to the network, concept specific protocols for communication among devices, and applications within the network, etc.) and agreements about representation of particular domain theories. The network ontology may be encoded in any suitable knowledge representation language, such as Web Ontology Language (OWL).

In one embodiment, the semantic reasoner 12 is a stream reasonser configured to infer logical consequences from a set of asserted facts or axioms. The semantic reasoner 12 may comprise, for example, a semantic mapper or pre-processing components operable to populate a knowledge database with data extracted from the network data according to the network ontology 19, for example. The semantic reasoner 12 may further comprise a reasoning engine configured to perform machine reasoning according to a semantic model, for example, using policies and rules from a policy database, and generate actions or reports appropriate for controlling and managing the network 14.

The optimization device 10 is configured to identify metrics based on the ontology 19 and instruct the stream reasoner 12 to monitor data streams to provide temporal readings of the metrics. The current values of the metrics, obtained from the semantic reasoner 12 are input to the LP solver 16 to obtain an initial solution of an optimization problem. The LP solver 16 may be any component or module (e.g., code, software, logic) operable to optimize a linear function subject to linear equality and linear inequality constraints. The LP solver 16 may use any type of programming or modeling language or software environment.

As the state or condition of the network 14 or compute infrastructure changes, the metrics may vary. As described in detail below, the LP solver trigger 18 is operable to automatically trigger the LP solver 16 to calculate a new optimal solution when the constraints of the LP formulation are being violated (i.e., no longer being met) through use of the semantic stream reasoner 12. In one embodiment, the optimization device 10 generates one or more filters 17 for installation at the semantic reasoner 12 for use in identifying when the optimization constraints are no longer being met. This allows the LP solver 16 to only run when the current placement/assignment within the infrastructure is no longer optimal. The LP solver trigger 18 may be any suitable mechanism or module (e.g., code, software, program) operable to trigger the LP solver 16 to calculate a new optimal solution based on input from the stream reasoner 12.

In one example, the stream reasoner 12 comprises a C-SPARQL (Continuous SPARQL Protocol and RDF (Resource Description Framework) Query Language) engine and the filters 17 are constructed using SPARQL FILTER primitive types.

One or more components shown in FIG. 1 may operate as part of an orchestration product (e.g., for virtual machine placement, foglet placement, or VNF (Virtual Network Function) placement) or as part of a data analytics solution or product. The optimization system may also operate as a service embedded in an SDN (Software Defined Networking) controller or application operating on top of a controller (e.g., for flow placement or ACL placement). In one example, an SDN controller may include network management and control logic with the ability to reason (i.e., perform machine reasoning) over various network data categories. The reasoning may be mechanized using semantic technologies, including ontology languages (e.g., Web Ontology Language (OWL), OWL-Descriptions Logics (OWL-DL), Resource Description Framework (RDF), Semantic Web Rule Language (SWRL), and the like. For example, in one embodiment the optimization problem is modeled in a semantic ontology using SWRL extensions. It is to be understood that these are only examples and that any modeling language may be used as long as the model captures both the objective function and the constraints.

Constraints of the optimization problem may be associated with resources (e.g., memory (RAM, TCAM, etc.), latency, bandwidth, or any other network or device limitations.

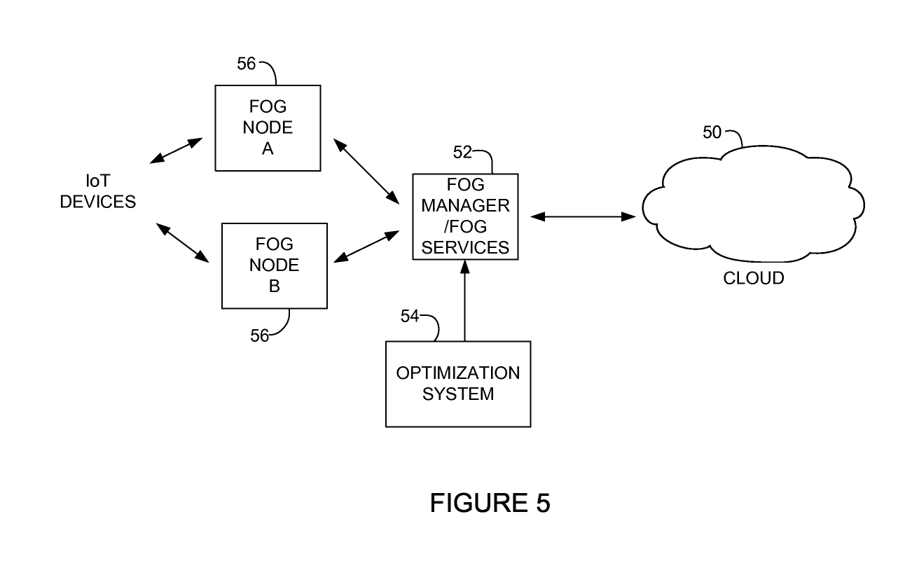

The optimization results may be provided to one or more network management devices, controller, service node, or other system or device for use in assigning flows to links or paths, placement of ACLs on network elements, placement of VMs/foglets in fog nodes, placement of virtual network functions, placement of VMs, containers, or applications in a network, assignment of wireless clients to access points, or any other network optimization problem. An example using the embodiments to place foglets at fog nodes is described below with respect to FIG. 5.

In addition to the functions described above, the optimization engine 10 may also be responsible for programming the LP solver 16 based on the optimization model captured in the ontology 19. The embodiments thus provide the flexibility to support any objective or constraints, without the need to write new code, by modeling the optimization problem in the ontology 19.

It is to be understood that the network shown in FIG. 1 and described above is only an example and the embodiments described herein may be implemented in networks comprising different network topologies or network devices, or using different protocols or languages, without departing from the scope of the embodiments. For example, the network may include any number or type of network devices that facilitate passage of data over the network (e.g., routers, switches, gateways, controllers), network elements that operate as endpoints or hosts (e.g., servers, virtual machines, clients), and any number of network sites or domains in communication with any number of networks. Thus, network nodes may be used in any suitable network topology, which may include any number of servers, accelerators, virtual machines, switches, routers, appliances, controllers, or other nodes interconnected to form a large and complex network, which may include cloud or fog computing. Nodes may be coupled to other nodes through one or more interfaces employing any suitable wired or wireless connection, which provides a viable pathway for electronic communications.

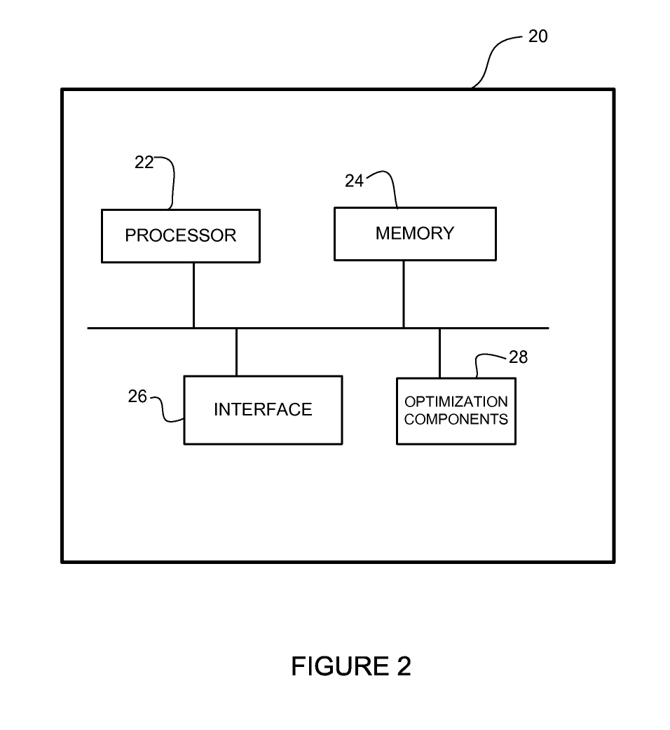

FIG. 2 illustrates an example of a network device 20 (e.g., optimization node 10 in FIG. 1) that may be used to implement the embodiments described herein. In one embodiment, the network device 20 is a programmable machine that may be implemented in hardware, software, or any combination thereof. The network device 20 includes one or more processor 22, memory 24, network interface 26, and optimization components 28 (e.g., optimization engine 15, LP solver 16, LP solver trigger 18 shown in FIG. 1)

Memory 24 may be a volatile memory or non-volatile storage, which stores various applications, operating systems, modules, and data for execution and use by the processor 22. Memory 24 may include, for example, one or more databases (e.g., network knowledge database, polices database, etc.) or any other data structure configured for storing policies, constraints, objectives, metrics, network data (e.g., topology, resources, capabilities, ontology), or other information. One or more optimization components 28 (e.g., code, logic, software, firmware, etc.) may also be stored in memory 24. The network device 20 may include any number of memory components.

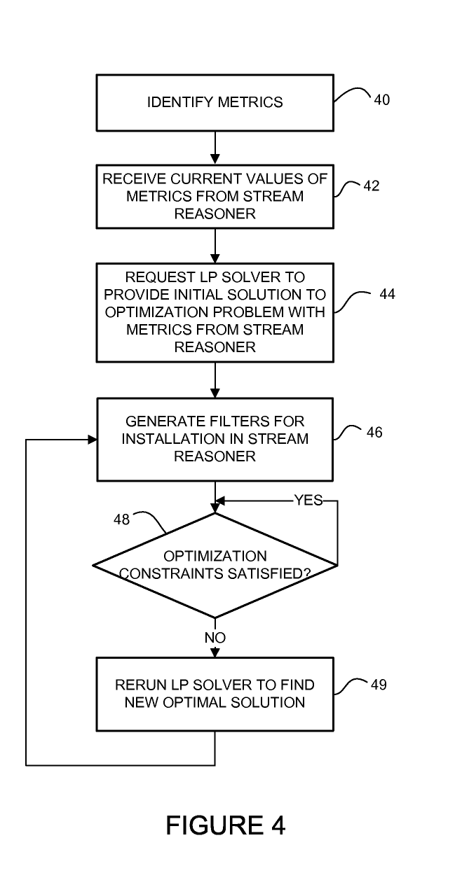

Logic may be encoded in one or more tangible media for execution by the processor 22. The processor 22 may be configured to implement one or more of the functions described herein. For example, the processor 22 may execute codes stored in a computer-readable medium such as memory 24 to perform the process described below with respect to FIG. 4. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium. In one example, the computer-readable medium comprises a non-transitory computer-readable medium. The network device 20 may include any number of processors 22.

The network interface 26 may comprise any number of interfaces (linecards, ports) for receiving data or transmitting data to other devices. The network interface 26 may include, for example, an Ethernet interface for connection to a computer or network. The network interface 26 may be configured to transmit or receive data using a variety of different communication protocols. The interface 26 may include mechanical, electrical, and signaling circuitry for communicating data over physical links coupled to the network.

It is to be understood that the network device 20 shown in FIG. 2 and described above is only an example and that different configurations of network devices may be used. For example, the network device 20 may further include any suitable combination of hardware, software, algorithms, processors, devices, components, modules, or elements operable to facilitate the capabilities described herein.

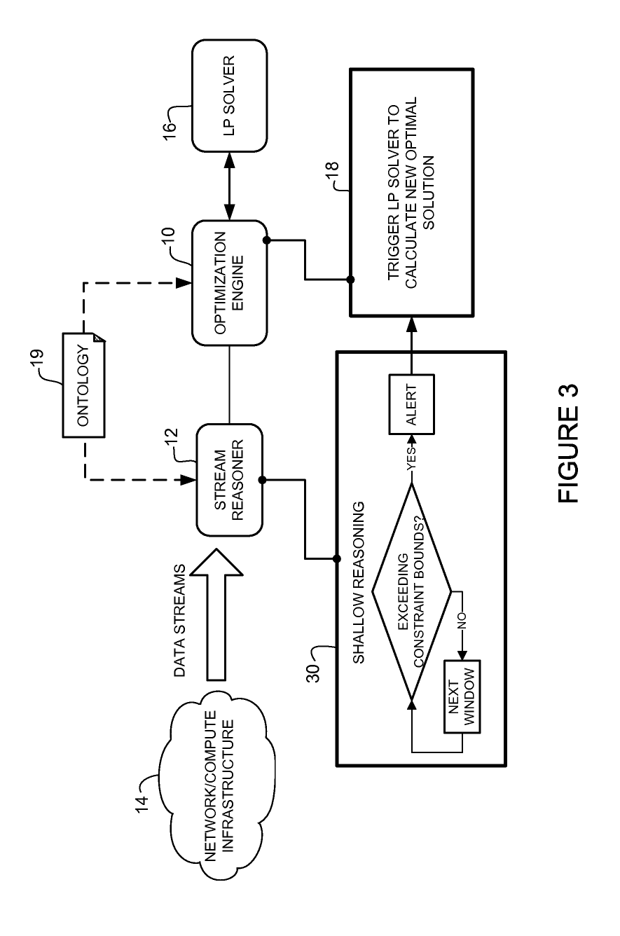

FIG. 3 illustrates operation of the LP solver trigger mechanism 18 shown in FIG. 1, in accordance with one embodiment. As previously described with respect to FIG. 1, the system includes the optimization engine 10, stream reasoner 12, LP solver 16, and LP solver trigger 18. The LP solver trigger 18 is operable to automatically trigger the LP solver 16 to rerun the optimization problem when the constraints of the LP formulation are being violated as indicated by the stream reasoning logic shown at block 30.

As shown in FIG. 3, network/compute infrastructure 14 transmits data streams to stream reasoner 12. The optimization engine 10 first examines the ontology 19 in order to identify the metrics that govern the constraints of the optimization problem. Once those metrics are identified, the optimization engine 10 instructs the stream reasoner 12 to start monitoring the data streams that provide temporal readings of these metrics. The metrics may comprise any network, device, or traffic parameter for which a value may be identified based on the data stream. As previously discussed, the values of these metrics will vary over time due to the state and conditions of the network and/or compute infrastructure 14. During a bootstrapping phase, the optimization engine 10 obtains the current values of the metrics from the stream reasoner 12 and triggers the LP solver 16 to provide the initial solution of the optimization problem. Subsequently, the optimization engine 10 may generate and install filters 17 in the stream reasoner 12 such that these filters cause the semantic query to match the data streams only when the optimization constraints are no longer being honored or satisfied (FIGS. 1 and 3). The optimization engine 10 may, for example, automatically derive the filters 17 by examining a combination of the model of the constraints in the ontology 19 and the initial solution to the optimization problem.

Any positive results identified by the stream reasoner 12 are fed to the optimization engine 10. For example, as shown in the logic of block 30, if the constraints identified by the stream reasoner 12 exceed the current constraint bounds (e.g., upper bound, lower bound, equality, or any combination thereof), an alert will be raised causing the LP trigger 18 to request the LP solver 16 to calculate a new optimal solution. The embodiments thus schedule the LP solver 16 to run only when current placement/assignment within the infrastructure is no longer optimal.

FIG. 4 is a flowchart illustrating an overview of a process for automatic triggering of LP solvers, in accordance with one embodiment. At step 40 metrics are identified at a network device (e.g., optimization device 10 in FIG. 1). The optimization device 10 instructs the stream reasoner 12 to monitor data streams for the identified metrics (step 42). Once the optimization device 10 obtains the current values of the metrics from the stream reasoner 12, it may request the LP solver 16 to solve an optimization problem using these initial metrics (step 44). Based on the results from the LP solver 16, the optimization device 10 generates one or more filters 17 for installation at the stream reasoner 12 (step 46). If the optimization constraints are no longer satisfied (i.e., violated) (step 48), the LP solver 16 is triggered to find a new optimal solution (step 49).

It is to be understood that the process shown in FIG. 4 and described above, is only an example and that steps may be added, deleted, combined, or modified without departing from the scope of the embodiments.

FIG. 5 depicts an example illustrating implementation of the embodiments described above for use in a fog computing environment. Fog computing is used to extend the cloud computing paradigm to the edge of the network. With the increase or variability in the number of edge nodes resulting from fog, mobility, and IoE (Internet of Everything), auto optimization according to the embodiments described herein may be used to match dynamic changes in the external environment.

As shown in FIG. 5, the network may include a fog manager or fog services node 52 in communication with a cloud 50. The fog manager 52 is in communication with a plurality of fog nodes 56 (fog node A, fog node B), which may be in communication with any number of network devices including Internet of Things (IoT) devices. The fog manager/service node 52 may, for example, apply rules to decide which data to process locally and which to send to the cloud 50. In this example, optimization system 54 is in communication with the fog manager 52 and operable to optimize foglet placement. The optimization system may include an optimization engine 10, stream reasoner 12, LP solver 16, and LP solver trigger 18, as described above with respect to FIGS. 1 and 3.

The following example illustrates a simplified foglet placement problem in which there are constraints on memory size. In this example, Foglet 1 requires 3 MB of RAM, Foglet 2 requires 2 MB, and Foglet 3 requires 7 MB. The network includes two fog nodes 56 (fog node A and fog node B) with initial available memory of 8 MB and 5 MB, respectively. The memory related constraints for the foglet placement problem may be formulated as follows:
Let pᵢⱼ=1 if Foglet 1 is placed on Node j; 0 otherwise.

3×p_{1,A}+2×p_{2,A}+7×p_{3,A}<=8 (Node A RAM Constraint)

3×p_{1,B}+2×p_{2,B}+7×p_{3,B}<=5 (Node B RAM Constraint)

While the above constraints are shown here in numeric formulae, it is to be understood that the embodiments may capture these constraints in an ontology (e.g. using RDF/OWL constructs).

In one example, the initial solution assigns Foglet 1 and Foglet 2 to Node B, and Foglet 3 to Node A. The optimization engine 10 may then render these two constraints into the proper programming of the stream reasoner 12 (FIGS. 3 and 5). In one embodiment where the stream reasoner 12 is a C-SPARQL engine, the constraints would yield the following semantic query in C-SPARQL (irrelevant details of the query are omitted for clarity and “?x” refers to “variable x”):

SELECT (?memoryA ?memoryB ?memoryFoglet1 ?memoryFoglet2
?memoryFoglet3) from STREAM ? WHERE { ?. Filter {(?memoryFoglet3
> ?memoryB) || (?memoryFoglet1 + ?memoryFoglet2 > ?memoryB)}}

As the memory demands of the foglets and the memory available on the fog nodes 56 change over time, the stream reasoner 12 may use the above query to determine whether the constraints of the placement are still within the required bounds, or whether a new placement needs to be calculated. When the query returns a match, the optimization engine 10 provides the updated set of metrics to the LP solver 16 and re-programs the LP solver to calculate the new placement solution.

While the above example shows a simple constraint along a single dimension (memory), it is to be understood that the embodiments described herein may be applied to complex multifaceted constraints that map to the composition of multiple data streams being fed to the stream reasoner 12.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
identifying at a network device, metrics associated with constraints of an optimization problem;
receiving at the network device, values for the metrics from a stream reasoner;
obtaining at the network device, an initial solution of said optimization problem from a linear programming solver based on said values of the metrics; and
instructing at the network device, the linear programming solver to calculate a new solution to said optimization problem when the stream reasoner indicates that the constraints of said optimization problem are violated.

2. The method of claim 1 further comprising generating a filter to install in the stream reasoner for use in identifying when the constraints of said optimization problem are violated.

3. The method of claim 2 wherein the filter is generated based on a model of the constraints and said initial solution of said optimization problem.

4. The method of claim 1 wherein identifying the metrics comprises examining a network ontology.

5. The method of claim 1 further comprising instructing the stream reasoner to monitor incoming data streams providing temporal readings of the metrics.

6. The method of claim 1 wherein said values of the metrics vary over time based on a state and condition of a network or compute infrastructure.

7. The method of claim 1 wherein the stream reasoner comprises a SPARQL (SPARQL Protocol and RDF (Resource Description Framework) Query Language) engine.

8. The method of claim 1 further comprising programming the LP solver based on an optimization model in a network ontology.

9. The method of claim 1 wherein said optimization problem comprises foglet assignment to fog nodes.

10. An apparatus comprising:
a processor configured to identify metrics associated with constraints of an optimization problem, process values for the metrics received from a stream reasoner, obtain an initial solution of said optimization problem from a linear programming solver based on said values of the metrics, and instruct the linear programming solver to calculate a new solution to said optimization problem when the stream reasoner indicates that the constraints of said optimization problem are violated; and
memory for storing the metrics and the constraints of said optimization problem.

11. The apparatus of claim 10 wherein the processor is further configured to generate a filter to install in the stream reasoner for use in identifying when the constraints of said optimization problem are violated.

12. The apparatus of claim 11 wherein the filter is generated based on a model of the constraints and said initial solution of said optimization problem.

13. The apparatus of claim 10 wherein identifying the metrics comprises examining a network ontology.

14. The apparatus of claim 10 wherein the processor is further configured for instructing the stream reasoner to monitor incoming data streams providing temporal readings of the metrics.

15. The apparatus of claim 10 wherein said values of the metrics vary over time based on a state and condition of a network or compute infrastructure.

16. The apparatus of claim 10 wherein the stream reasoner comprises a C-SPARQL (Continuous SPARQL Protocol and RDF (Resource Description Framework) Query Language) engine.

17. The apparatus of claim 10 wherein the processor is further configured for programming the LP solver based on an optimization model in a network ontology.

18. Logic encoded on one or more non-transitory computer readable media for execution and when executed on a processor operable to:
identify metrics associated with constraints of an optimization problem;
process values for the metrics received from a stream reasoner;
obtain an initial solution of said optimization problem from a linear programming solver based on said values of the metrics; and
instruct the linear programming solver to calculate a new solution to said optimization problem when the stream reasoner indicates that the constraints of said optimization problem are violated.

19. The logic of claim 18 wherein the logic is further operable to generate a filter to install in the stream reasoner for use in identifying when the constraints of said optimization problem are violated.

20. The logic of claim 18 wherein the logic is further operable to program the LP solver based on an optimization model in a network ontology.
